(19) United States
(12) Patent Application Publication
(10) Pub. No.: US 2022/0185318 A1
(43) Pub. Date: Jun. 16, 2022

(54) INFORMATION PROCESSING DEVICE, INFORMATION PROCESSING SYSTEM, AND PROGRAM

(71) Applicant: TOYOTA JIDOSHA KABUSHIKI KAISHA, Toyota-shi (JP)

(72) Inventors: Masato EHARA, Gotemba-shi (JP); Kazuhiro SHIMIZU, Sunto-gun (JP); Satoshi TANABE, Mishima-shi (JP); Nanae TAKADA, Susono-shi (JP); Naohiro SEO, Sunto-gun (JP)

(73) Assignee: TOYOTA JIDOSHA KABUSHIKI KAISHA, Toyota-shi (JP)

(21) Appl. No.: 17/475,988

(22) Filed: Sep. 15, 2021

(30) Foreign Application Priority Data
Dec. 15, 2020 (JP) 2020-207939

(51) Int. Cl. B60W 60/00; G06K 9/00; B60W 40/09; G06N 20/00

(52) U.S. Cl. CPC B60W 60/001; G06K 9/00791; B60W 2420/42; G06N 20/00; B60W 40/09

(57) ABSTRACT

An information processing device is provided with a processor including hardware. The processor is configured to: acquire image information acquired by capturing an image of an item collected by a moving body and store the image information in a storage unit; determine whether the item in the image information read from the storage unit is waste; when the processor determines that the item is not waste, output an instruction signal for keeping the item in the moving body and output information related to the item based on the image information; and when user identification information associated with the information related to the item exists in the storage unit, output an instruction signal for moving to a predetermined location.

### CROSS-REFERENCE TO RELATED APPLICATION

This application claims priority to Japanese Patent Application No. 2020-207939 filed on Dec. 15, 2020, incorporated herein by reference in its entirety.

### BACKGROUND

### 1. Technical Field

The present disclosure relates to an information processing device, an information processing system, and a program.

### 2. Description of Related Art

Japanese Unexamined Patent Application Publication No. 2010-204733 (JP 2010-204733 A) discloses a technique of automatically tagging captured images of lost items, establishing a database that can search and manage the lost items using the tags as keys so that the owner can search for lost items, and when lost item information that matches the search conditions is searched, presenting the lost item information after authentication of causing the owner to select a partial image from a partial image and a dummy image. The technique described in JP 2010-204733 A automatically tags the captured images of the lost items, establishes a database that can search and manage the lost items using the tags as keys so that the owner can search for lost items left behind by the owner using the tags as keys, and even when the lost item information that matches the search conditions specified by the owner is searched, presents the lost item information after authentication of causing the owner to select a partial image from a partial image and a dummy image, instead of outputting the lost item information as it is.

### SUMMARY

However, in the technique described in JP 2010-204733 A, no study is made on the collaboration between the search device for lost items and a cleaning moving body such as an automatic cleaning robot that operates in a specific area. Further, in the technique described in JP 2010-204733 A, it is difficult to constitute a device having a series of functions of finding and keeping a lost item and delivering the lost item to the owner when the owner of the lost item appears. Therefore, there has been a demand for the development of a device that can realize functions of determining whether the item collected by the cleaning moving body that performs automatic cleaning is waste, keeping the item when the item is not waste, and further delivering the item.

The present disclosure has been made in view of the above, and an object thereof is to provide an information processing device, an information processing system, and a program that can realize functions of determining whether an item collected by a moving body is waste, and keeping and delivering the item when the item is not waste.

An information processing device according to the present disclosure is provided with a processor including hardware. The processor is configured to: acquire image information acquired by capturing an image of an item collected by a moving body and store the image information in a storage unit; determine whether the item in the image information read from the storage unit is waste; when the processor determines that the item is not waste, output an instruction signal for keeping the item in the moving body and output information related to the item based on the image information; and when user identification information associated with the information related to the item exists in the storage unit, output an instruction signal for moving to a predetermined location.

An information processing system according to the present disclosure includes: a first device including a work unit that collects an item, an imaging unit that captures an image of the item, and a first processor that includes hardware, that acquires operation information related to operation, and that outputs an instruction signal for moving based on the operation information; and a second device including a second processor that includes hardware, that acquires image information acquired by capturing the image of the item collected by the first device and stores the image information in a storage unit, that determines whether the item in the image information read from the storage unit is waste, that, when the processor determines that the item is not waste, outputs an instruction signal for keeping the item in the first device and outputs information related to the item based on the image information, and that, when user identification information associated with the information related to the item exists in the storage unit, outputs an instruction signal for moving to a predetermined location to the first device.

A program according to the present disclosure causes a processor including hardware to: acquire image information acquired by capturing an image of an item collected by a moving body and store the image information in a storage unit; determine whether the item in the image information read from the storage unit is waste; when the processor determines that the item is not waste, output an instruction signal for keeping the item in the moving body and output information related to the item based on the image information; and when user identification information associated with the information related to the item exists in the storage unit, output an instruction signal for moving to a predetermined location.

According to the present disclosure, functions of determining whether an item collected by a moving body is waste, and keeping and delivering the item when the item is not waste can be realized.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a management system according to an embodiment;

FIG. 2 is a block diagram schematically showing a configuration of an operation management server according to the embodiment;

FIG. 3 is a block diagram schematically showing a configuration of a lost item management server according to the embodiment;

FIG. 4 is a block diagram schematically showing a configuration of a cleaning moving body according to the embodiment;

FIG. 5 is a block diagram schematically showing a configuration of a user terminal according to the embodiment;

FIG. 6 is a flowchart illustrating a management method according to the embodiment;

FIG. 7A is a diagram showing an example of a selection screen of a search application output to an input/output unit of the user terminal according to the embodiment;

FIG. 7B is a diagram showing an example of a list screen of the search application output to the input/output unit of the user terminal according to the embodiment;

FIG. 7C is a diagram showing an example of a registration screen of the search application output to the input/output unit of the user terminal according to the embodiment;

FIG. 8A is a diagram showing a display example of a match result of a lost item of the search application output to the input/output unit of the user terminal according to the embodiment; and

FIG. 8B is a diagram showing a display example of a selection result of the lost item of the search application output to the input/output unit of the user terminal according to the embodiment.

### DETAILED DESCRIPTION OF EMBODIMENTS

Hereinafter, embodiments of the present disclosure will be described below with reference to the drawings. In all the drawings of the following embodiments, the same or corresponding portions are designated by the same reference numerals. Further, the present disclosure is not limited to the embodiments described below.

In recent years, studies have been made on cleaning moving bodies such as automatic cleaning robots used in a predetermined area. However, lost items may be present on the road in addition to waste. If there is a lost item on the road, there is a request to return the lost item to the owner who left the lost item behind. Therefore, with the present disclosure, there is desired a technique of a sorting device for sorting whether a found item left on the road and collected is waste or a lost item. The present disclosure proposes a method of handing, from a cleaning moving body to an owner, an item determined to be a lost item by a sorting device. The embodiment described below is based on the above proposal.

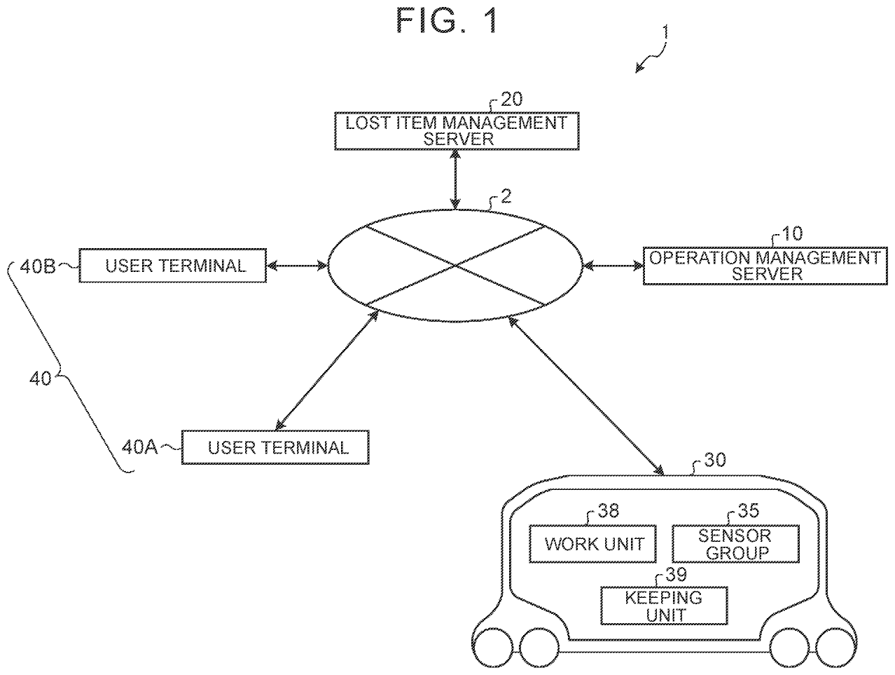

First, a management system to which an information processing device according to the embodiment of the present disclosure can be applied will be described. FIG. 1 is a schematic view showing a management system 1 according to the present embodiment. As shown in FIG. 1, the management system 1 according to the present embodiment includes an operation management server 10, a lost item management server 20, a work vehicle 30 including a sensor group 35, a keeping unit 39, and a work unit 38, and user terminals 40A and 40B, that can communicate with each other via a network 2. In the following description, information is transmitted and received between each component via the network 2. However, the description of transmission and reception via the network 2 will be omitted.

The network 2 is composed of, for example, the Internet network and a mobile phone network. The network 2 is, for example, a public communication network such as the Internet, and may include a telephone communication network such as a wide area network (WAN) and a mobile phone, and other communication networks such as a wireless communication network including WiFi.

Operation Management Server

The operation management server 10 serving as an operation management device for the work vehicle 30 manages the operation of the work vehicle 30. In the present embodiment, various pieces of information such as vehicle information, operation information, and item information are supplied to the operation management server 10 from each work vehicle 30 at a predetermined timing. The vehicle information includes vehicle identification information, sensor information, and location information. The sensor information includes, but is not necessarily limited to, energy remaining amount information related to the remaining energy amount such as the fuel remaining amount and the battery state of charge (SOC) of the work vehicle 30, and information related to traveling of the work vehicle 30 such as speed information and acceleration information. The item information includes, but is not necessarily limited to, various pieces of information related to the item such as image information and video information obtained by capturing an image of the item on the road.

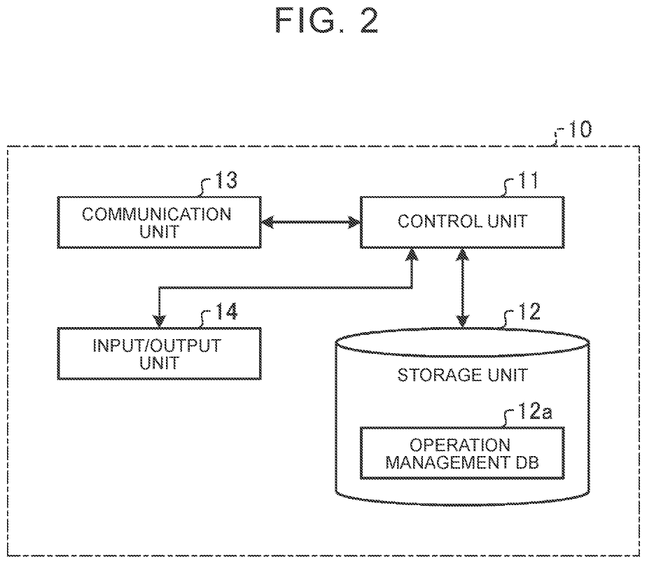

FIG. 2 is a block diagram schematically showing a configuration of the operation management server 10. As shown in FIG. 2, the operation management server 10 serving as a third device has a configuration of a general computer capable of communicating via the network 2. The operation management server 10 includes a control unit 11, a storage unit 12, a communication unit 13, and an input/output unit 14.

The control unit 11 serving as a third processor provided with hardware that manages the operation is composed of a processor such as a central processing unit (CPU), a digital signal processor (DSP), and a field-programmable gate array (FPGA), and a main storage unit such as a random access memory (RAM) and a read-only memory (ROM). The storage unit 12 includes, for example, a recording medium selected from an erasable programmable ROM (EPROM), a hard disk drive (HDD), and a removable medium, etc. Examples of the removable media include disc recording media such as a universal serial bus (USB) memory, a compact disc (CD), a digital versatile disc (DVD), and a Blu-ray (registered trademark) disc (BD). The storage unit 12 can store an operating system (OS), various programs, various tables, various databases, etc. The control unit 11 loads a program stored in the storage unit 12 into a work area of the main storage unit and executes the loaded program, and controls each component unit and the like through execution of the program. The program may be a learned model generated through machine learning, for example. The learned model is also called a learning model or a model.

The storage unit 12 stores an operation management database 12a in which various data are stored in a searchable manner. The operation management database 12a is, for example, a relational database (RDB). The database (DB) described below is established when the program of a database management system (DBMS) executed by the processor manages the data stored in the storage unit 12. In the operation management database 12a, the vehicle identification information of the vehicle information is associated with other information such as the operation information, and is stored in a searchable manner. When the operation management server 10 communicates with the user terminals 40A and 40B, it is also possible to associate unique user identification information for identifying the user terminals 40A and 40B with the user input information input to the user terminals 40A and 40B by the user, and store the information in the operation management database 12a.

The vehicle identification information assigned to each work vehicle 30 is stored in the operation management database 12a in a searchable manner. The vehicle identification information includes various pieces of information for identifying the individual work vehicles 30 from each other, and includes information necessary for accessing the operation management server 10 when transmitting information related to the work vehicle 30. The vehicle identification information is also transmitted when the work vehicle 30 transmits various pieces of information. When the work vehicle 30 transmits predetermined information such as the vehicle information and sensor information together with the vehicle identification information to the operation management server 10, the operation management server 10 stores the predetermined information in the operation management database 12a in a searchable manner and in association with the vehicle identification information. Similarly, the user identification information includes various pieces of information for identifying individual users from each other. The user identification information is, for example, a user ID capable of identifying individual user terminals 40A and 40B, and includes information necessary for accessing the operation management server 10 when transmitting information related to the user terminals 40A and 40B. When the user terminals 40A and 40B transmit predetermined information such as the user input information together with the user identification information to the operation management server 10, the operation management server 10 stores the predetermined information in the operation management database 12a of the storage unit 12 in a searchable manner and in association with the user identification information.

The communication unit 13 is, for example, a local area network (LAN) interface board or a wireless communication circuit for wireless communication. The LAN interface board and the wireless communication circuit are connected to the network 2 such as the Internet, which is a public communication network. The communication unit 13 connects to the network 2 and communicates with the lost item management server 20, the work vehicle 30, and the user terminals 40A and 40B. The communication unit 13 receives the vehicle identification information and the vehicle information unique to the work vehicle 30 from each work vehicle 30, and transmits various instruction signals and confirmation signals to each work vehicle 30. Further, the communication unit 13 transmits information to the user terminal 40 (40A and 40B) owned by the user when the user uses the work vehicle 30, and receives, from the user terminal 40, user identification information for identifying the user and various pieces of information.

The input/output unit 14 may be composed of, for example, a touch panel display, a speaker microphone, or the like. The input/output unit 14 serving as an output unit is configured to, in accordance with control by the control unit 11, display characters, figures, and the like on the screen of a display such as a liquid crystal display, an organic electroluminescent (EL) display, or a plasma display, and output sound from a speaker to notify the outside of predetermined information. The input/output unit 14 includes a printer that outputs predetermined information by printing the information on printing paper or the like. Various pieces of information stored in the storage unit 12 can be confirmed, for example, on the display of the input/output unit 14 installed in a predetermined office or the like. The input/output unit 14 serving as an input unit is composed of, for example, a keyboard or a touch panel keyboard incorporated in the input/output unit 14 to detect a touch operation on the display panel, or a voice input device enabling the user to make a call to the outside. Inputting predetermined information from the input/output unit 14 of the operation management server 10 makes it possible to remotely manage the operation of the work vehicle 30, so that the operation of the work vehicle 30 that is an autonomous driving vehicle capable of autonomous driving can be easily managed.

Lost Item Management Server

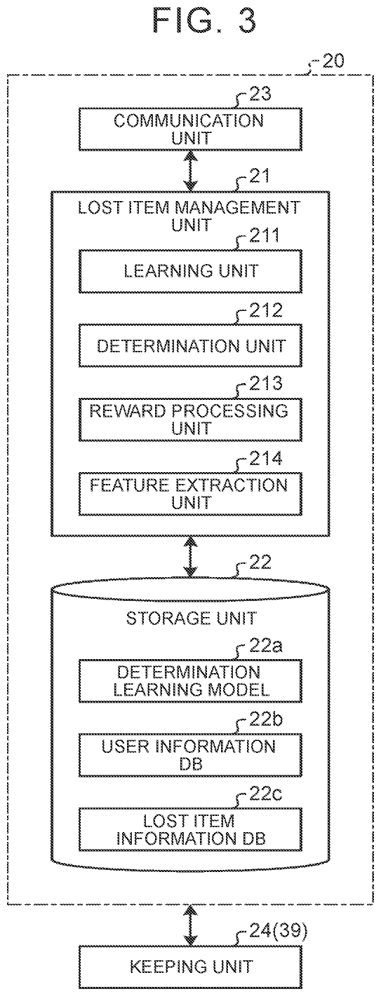

The lost item management server 20 serving as a second device and the information processing device manages a keeping unit 24 for keeping the lost item, and can determine whether the item found by the work vehicle 30 is waste. FIG. 3 is a block diagram schematically showing a configuration of the lost item management server 20. As shown in FIG. 3, the lost item management server 20 has a configuration of a general computer capable of communicating via the network 2, and includes a lost item management unit 21, a storage unit 22, and a communication unit 23. Various pieces of information such as image information and video information (hereinafter collectively referred to as image information) are supplied from the work vehicle 30 to the lost item management server 20.

The lost item management unit 21, the storage unit 22, and the communication unit 23 have the same functional and physical configurations as the control unit 11, the storage unit 12, and the communication unit 13, respectively. The storage unit 22 can store various programs, various tables, various databases, and the like, such as an OS, a determination learning model 22a, a user information database 22b, and a lost item information database 22c. The lost item management unit 21 serving as a second processor provided with hardware loads a program such as the determination learning model 22a stored in the storage unit 22 into the work area of the main storage unit and executes the program, so that the functions of a learning unit 211 and a determination unit 212 can be realized through the execution of the program. The learning model can be generated through machine learning such as deep learning using a neural network, for example, with an input-output data set of a predetermined input parameter and an output parameter as teacher data. As a result, the lost item management unit 21 can realize the functions of the learning unit 211, the determination unit 212, and a reward processing unit 213.

The lost item management unit 21 uses the determination learning model 22a stored in the storage unit 22 to determine whether the found item included in the image information is waste, based on the image information acquired in response to the found item obtained by the work vehicle 30. Here, a method of generating the determination learning model 22a, which is a program stored in the storage unit 22, will be described.

In the present embodiment, the function of the learning unit 211 is executed when the program is executed by the lost item management unit 21. The learning unit 211 uses, as teacher data, an input and output data set that uses a plurality of pieces of image information obtained by capturing images of a plurality of items as a learning input parameter and a determination result of whether each of the items is waste as a learning output parameter, to generate the determination learning model 22a. That is, the learning unit 211 can generate the determination learning model 22a by using, as the teacher data, the input and output data set that uses the image information acquired by capturing images by the imaging unit 35a as the learning input parameter and the result of determining whether the item is waste for each of the pieces of image information as the learning output parameter. That is, the learning unit 211 performs machine learning based on the input and output data set acquired by the lost item management server 20. The determination learning model 22a is a learning model capable of determining whether the found item is waste from the image of the found item included in the image information, based on the image information acquired by capturing images by the imaging unit 35a of the work vehicle 30. The learning unit 211 writes and stores the learned result in the storage unit 22. The learning unit 211 may cause the storage unit 22 to store the latest learned model at a predetermined timing separately from the neural network that is performing learning. When causing the storage unit 22 to store the latest learned model, updating may be performed in which the old learning model is deleted and the latest learning model is stored, or accumulation may be performed in which the latest learning model is stored while a part or all of the old learning model remains stored. The various programs also include a model update processing program. The determination unit 212 executes a function of determining whether the item included in the image information is waste when the lost item management unit 21 executes the program, that is, the determination learning model 22a. The learning model is also called a learned model or a model. It is also possible to perform rule-based processing instead of the learning model.

The reward processing unit 213 can calculate a reward amount for the user who owns the user terminal 40, based on the image information received and acquired from the user terminal 40. The reward amount for the user may be determined based on the value of the lost item based on the image information or the location information of the location where the lost item is found, and various determination methods can be adopted.

In the user information database 22b, the user input information acquired from each user terminal 40 is stored in association with the user identification information. In the lost item information database 22c, information related to the found item that the determination unit 212 of the lost item management unit 21 has determined is not waste, that is, the lost item (lost item information), is stored in association with a unique ID (lost item ID) for each lost item in a searchable manner.

The communication unit 23 is connected to the network 2 and communicates with the operation management server 10, the work vehicle 30, and the user terminal 40. The keeping unit 24 is configured to be able to keep the item that was left behind and that was found by the work vehicle 30. When the information processing device having the same configuration as the lost item management server 20 is mounted on the work vehicle 30, the keeping unit 24 functions as the keeping unit 39 of the work vehicle 30.

Work Vehicle

The work vehicle 30 serving as a moving body as the first device is a moving body capable of performing a plurality of types of predetermined tasks such as collection, transportation, and delivery of waste and lost items left on the road. An autonomous driving vehicle configured to be capable of autonomously traveling according to an operation command given by the operation management server 10, a predetermined program, or the like can be adopted as the moving body. The work vehicle 30 is a moving body provided with an imaging unit capable of capturing images of items such as items left on the road.

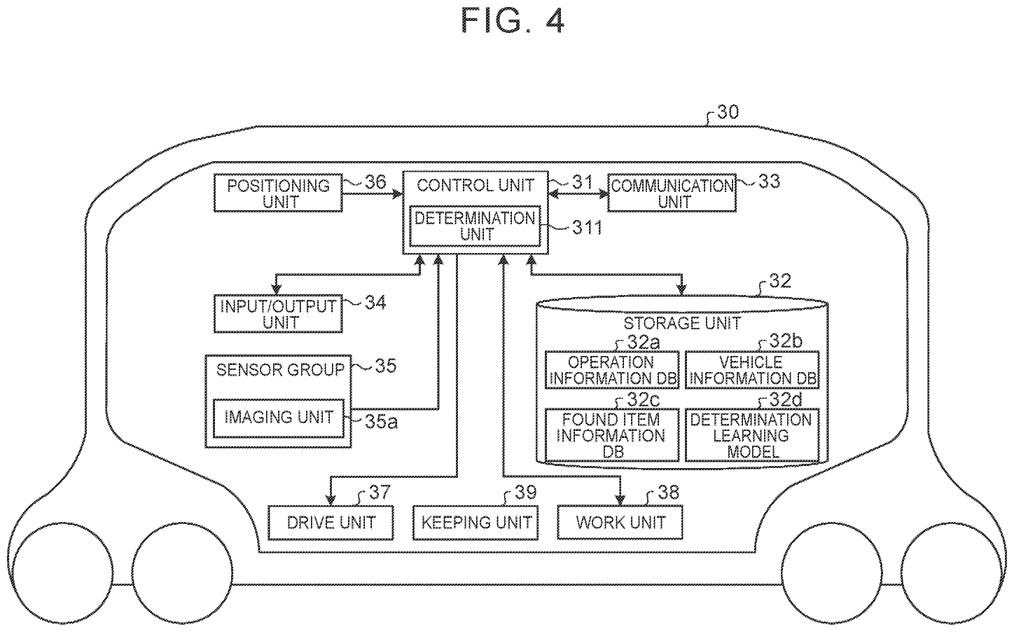

FIG. 4 is a block diagram schematically showing a configuration of the work vehicle 30. As shown in FIG. 4, the work vehicle 30 includes a control unit 31, a storage unit 32, a communication unit 33, an input/output unit 34, a sensor group 35, a positioning unit 36, a drive unit 37, a work unit 38, and a keeping unit 39. For example, a moving body equipped with an automatic cleaning robot or the like can be adopted as the work vehicle 30. The control unit 31, the storage unit 32, the communication unit 33, and the input/output unit 34 have the same physical and functional configurations as the control unit 11, the storage unit 12, the communication unit 13, and the input/output unit 14, respectively.

The control unit 31 serving as a first processor provided with hardware comprehensively controls the operation of various components mounted on the work vehicle 30. The storage unit 32 can store an operation information database 32a, a vehicle information database 32b, a found item information database 32c, and a determination learning model 32d. The operation information database 32a stores various types of data including the operation information provided by the operation management server 10 in an updateable manner. The vehicle information database 32b stores various pieces of information including the battery SOC, the remaining fuel amount, the current location, and the like in an updateable manner. The found item information database 32c stores found item information related to the found item collected by the work unit 38 of the work vehicle 30 in an updateable, deletable, and searchable manner. In the present embodiment, the found item information includes the image information of the found item.

The communication unit 33 communicates with the operation management server 10, the lost item management server 20, and the user terminal 40 by wireless communication via the network 2. The input/output unit 34 serving as an output unit is configured so that predetermined information can be notified to the outside. The input/output unit 34 serving as an input unit is configured so that a user or the like can input predetermined information to the control unit 31.

The sensor group 35 includes an imaging unit 35a serving as an imaging unit capable of capturing the image of the outside of the work vehicle 30 such as the work unit 38 and the road, and the inside of the work vehicle 30 such as the keeping unit 39. The imaging unit 35a is composed of an image sensor such as a complementary metal-oxide semiconductor (CMOS) or a charge-coupled device (CCD) camera and imaging elements. Specifically, when the work vehicle 30 is an automatic cleaning robot, the imaging unit 35a has a camera function. In addition to the imaging unit 35a, the sensor group 35 may include sensors related to the traveling of the work vehicle 30 such as a vehicle speed sensor, an acceleration sensor, and a fuel sensor, a vehicle cabin sensor capable of detecting various conditions in the vehicle cabin, a vehicle cabin imaging camera, or the like. The sensor information including the image information detected by the various sensors constituting the sensor group 35 is output to the control unit 31 via the vehicle information network (control area network (CAN)) composed of transmission lines connected to the various sensors. In the present embodiment, the sensor information other than the image information constitutes a part of the vehicle information.

The positioning unit 36 serving as a location information acquisition unit receives radio waves from a global positioning system (GPS) satellite and detects the location of the work vehicle 30. The detected location is stored in a searchable manner in the vehicle information database 32b as the location information in the vehicle information. As a method for detecting the location of the work vehicle 30, a method combining light detection and ranging or laser imaging detection and ranging (LiDAR) system and a three-dimensional digital map may be adopted. Further, the location information may be included in the operation information, and the location information of the work vehicle 30 detected by the positioning unit 36 may be stored in the operation information database 32a.

The drive unit 37 is a drive unit for causing the work vehicle 30 to travel. Specifically, the work vehicle 30 includes an engine and a motor as a drive source. The engine is configured to be able to generate electric power using an electric motor or the like by being driven by combustion of fuel. A rechargeable battery is charged using the generated electric power. The motor is driven by the battery. The work vehicle 30 includes a drive transmission mechanism for transmitting a driving force of the engine and the motor, drive wheels for traveling, and the like. The drive unit 37 differs depending on whether the work vehicle 30 is an electric vehicle (EV), a hybrid vehicle (HV), a fuel cell vehicle (FCV), a compressed natural gas (CNG) vehicle, or the like, but detailed description thereof will be omitted.

The work unit 38 is a mechanism that collects an item that has fallen or that has been left behind on the road or the like, and that stores the item in the keeping unit 39. The keeping unit 39 is a keeping area for keeping an item such as an item that was left behind and that was collected by the work unit 38 as a found item. The found item collected by the work unit 38 may divide the keeping area in the keeping unit 39 according to whether the found item is waste. In this case, it is possible to classify the found items into waste and lost items.

The control unit 31 in the work vehicle 30 can also execute a part of the functions of the lost item management server 20. That is, the control unit 31 may include a learning unit, a feature extraction unit, or a reward processing unit in addition to the determination unit 311.

User Terminal

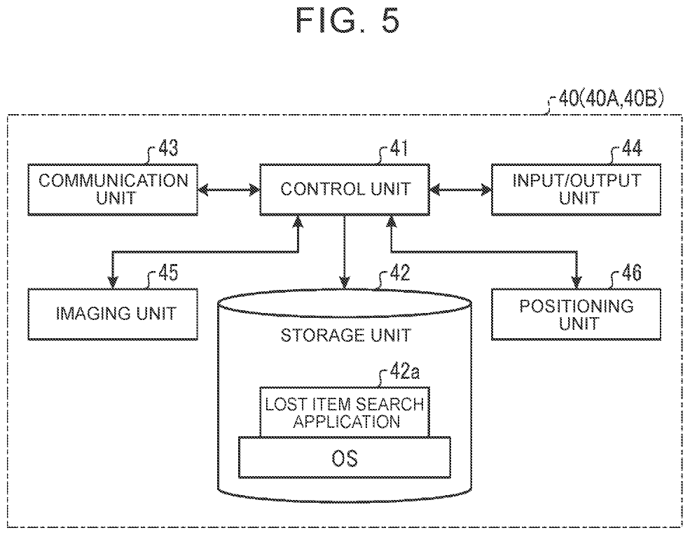

The user terminal 40 (40A, 40B) serving as a use terminal is operated by the user. The user terminal 40 can transmit various pieces of information such as the user information including the user identification information and the user input information to the lost item management server 20 by, for example, various programs such as a lost item search application 42a or a call using voice. The user terminal 40 is configured to be able to receive various pieces of information such as display information from the lost item management server 20. FIG. 5 is a block diagram schematically showing the configuration of the user terminal 40 (40A and 40B).

As shown in FIG. 5, the user terminal 40 includes a control unit 41, a storage unit 42, a communication unit 43, an input/output unit 44, an imaging unit 45, and a positioning unit 46, which are connected to each other so as to be able to communicate with each other. The control unit 41, the storage unit 42, the communication unit 43, the input/output unit 44, the imaging unit 45, and the positioning unit 46 have the same physical and functional configurations as the control unit 11, the storage unit 12, the communication unit 13, the input/output unit 14, the imaging unit 35a, and the positioning unit 36, respectively. Here, in the user terminal 40, the call with the outside includes not only a call with another user terminal 40 but also a call with an operator resident in the lost item management server 20 or an artificial intelligence system. The input/output unit 44 may be separately configured as an input unit and an output unit. As the user terminals 40A and 40B, specifically, a mobile phone such as a smartphone, a laptop type or a tablet type information terminal, a laptop type or desktop type personal computer, etc. can be adopted.

The control unit 41 comprehensively controls the operations of the storage unit 42, the communication unit 43, and the input/output unit 44 by executing the OS and various application programs stored in the storage unit 42. The storage unit 42 is configured to be able to store the lost item search application 42a and the user identification information. The communication unit 43 transmits and receives various pieces of information such as the user identification information, the user input information, and the lost item information to and from the lost item management server 20 and the like via the network 2.

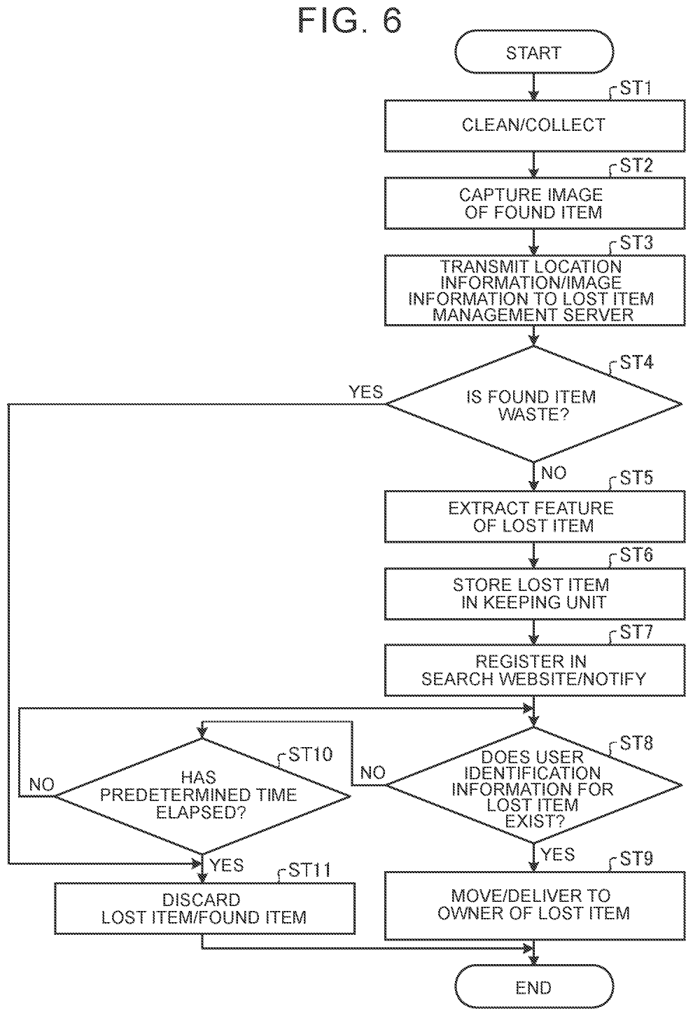

Next, a management method according to the present embodiment will be described. FIG. 6 is a flowchart illustrating a management method according to the present embodiment. In the following description, information is transmitted and received via the network 2. However, the description of transmission and reception via the network 2 will be omitted. Further, when information is transmitted and received among each work vehicle 30 and each user terminal 40A and 40B, the information is transmitted and received in association with the identification information to independently identify each work vehicle 30 and each user terminal 40A and 40B. However, the description thereof will also be omitted. Further, the flowchart shown in FIG. 6 shows processing related to one found item collected by the work vehicle 30, and thus the flowchart shown in FIG. 6 is executed for each found item.

As shown in FIG. 6, first, in step ST1, the work vehicle 30 travels or moves on a road, an area, or indoors in a predetermined area called a smart city, for example, to clean or collect items that were left behind. Subsequently, in step ST2, the imaging unit 35a of the work vehicle 30 captures an image of the found item collected by the work unit 38. The image information acquired by capturing the image by the imaging unit 35a is stored in the found item information database 32c of the storage unit 32 by the control unit 31. Subsequently, in step ST3, the control unit 31 transmits the image information acquired by capturing the image by the imaging unit 35a to the lost item management server 20.

Next, in step ST4, the determination unit 212 of the lost item management unit 21 in the lost item management server 20 inputs the image information transmitted and acquired from the work vehicle 30 as an input parameter to the determination learning model 22a. The determination unit 212 outputs information as to whether the found item included in the image information is waste as an output parameter of the determination learning model 22a. Since the output parameter may be output as the probability of being waste, in this case, it may be determined that the found item is waste when the probability that the found item is waste is equal to or greater than a predetermined probability. When the determination unit 212 determines that the found item is not waste (step ST4: No), the lost item management unit 21 stores the image information in the lost item information database 22c of the storage unit 22 and proceeds to step ST5.

Alternatively, the determination unit 311 of the control unit 31 in the work vehicle 30 inputs the image information acquired from the imaging unit 35a as an input parameter to the determination learning model 32d. The determination unit 212 outputs information as to whether the found item included in the image information is waste as an output parameter of the determination learning model 32d. Since the output parameter may be output as the probability of being waste, in this case, it may be determined that the found item is waste when the probability that the found item is waste is equal to or greater than a predetermined probability. When the determination unit 311 determines that the found item is not waste (step ST4: No), the control unit 31 stores the image information in the found item information database 32c of the storage unit 32 and proceeds to step ST5.

That is, at least one of the lost item management server 20 and the work vehicle 30 determines whether the found item collected by the work unit 38 of the work vehicle 30 is waste. Further, it may be set in advance which determination is prioritized, when the lost item management server 20 and the work vehicle 30 determine whether the found item is waste, and the determinations of the determination unit 212 of the lost item management server 20 and the determination unit 311 of the work vehicle 30 are different.

In step ST5, a feature extraction unit 214 of the lost item management unit 21 extracts the feature of the lost item based on the image information. For example, when the lost item is a bag or the like, features such as a brand name, a color, a size, and a model number are extracted from the image information to generate the lost item information including the image information. Further, for example, when the lost item is glasses or the like, features such as a brand name, a material, and a type are extracted from the image information to generate the lost item information. The lost item information generated by the feature extraction unit 214 is stored in the lost item information database 22c of the storage unit 22.

Further, in step ST6, the control unit 31 of the work vehicle 30 controls the work unit 38 and stores the found item in the keeping unit 39. Note that step ST6 can be executed in parallel or in reverse order with steps ST3 to ST5.

After that, in step ST7, the feature extraction unit 214 of the lost item management unit 21 registers the generated lost item information in a search website for lost items. The lost item management unit 21 of the lost item management server 20 performs predetermined image processing on the acquired image information, posts the image information on a predetermined search website for lost items together with the generated lost item information, and notifies the outside. This makes it possible to acquire a part of the lost item information by accessing the search website of the lost item management server 20 with the user terminal 40 or the like.

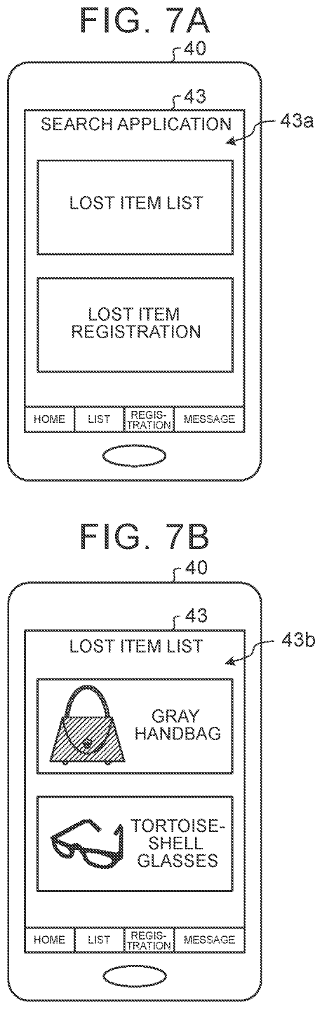

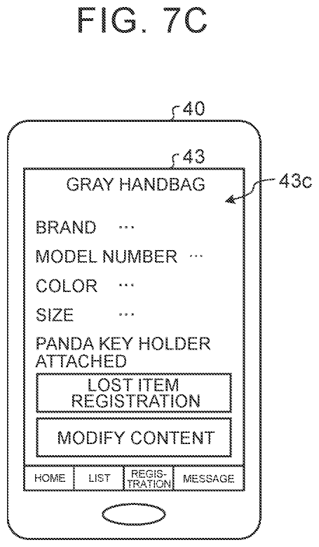

FIGS. 7A, 7B, and 7C are diagrams showing examples of display on the input/output unit 44 of the user terminal 40 displaying the search website for the lost items generated by the lost item management server 20. In the present embodiment, the control unit 41 of the user terminal 40 installs the lost item search application downloaded from the lost item management server 20 in the storage unit 42. For example, when the user identification information is transmitted from the user terminal 40 to the lost item management server 20, as shown in FIG. 7A, a selection screen 43a of the search application is displayed on the input/output unit 44 through communication with the lost item management server 20.

In the user terminal 40, when the user taps a “lost item list” icon displayed on the selection screen 43a or a “list” icon displayed on the lower side of the selection screen 43a, the control unit 41 transmits user selection information including the selected information of the lost item list or the list to the lost item management server 20. The lost item management server 20 transmits, to the user terminal 40, information corresponding to the information selected by the user terminal 40, based on the received user selection information, and displays the information on the input/output unit 44. In the following description, the description of each time the lost item management server 20 transmits, to the user terminal 40, information to be displayed on the input/output unit 44 of the user terminal 40 will be omitted. As shown in FIG. 7B, when the user taps the list, a lost item list screen 43b is displayed based on the lost item information acquired by the lost item management server 20.

Further, in the user terminal 40, when the user taps a “lost item registration” icon displayed on the selection screen 43a or a “registration” icon displayed on the lower side of the selection screen 43a, the control unit 41 transmits user selection information including the selected information of the lost item registration or the registration to the lost item management server 20. A registration screen 43c is displayed on the input/output unit 44 of the user terminal 40. As shown in FIG. 7C, when the user inputs lost item information such as brand, model number, color, and size and then taps “lost item registration”, the control unit 41 transmits the user selection information including the input lost item information to the lost item management server 20. When the user taps “modify content”, the input content can be changed or modified. The lost item management unit 21 of the lost item management server 20 stores the acquired user selection information in the lost item information database 22c.

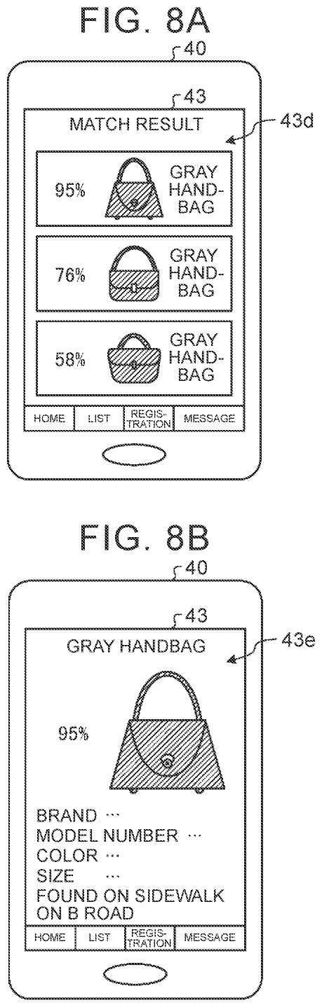

FIGS. 8A and 8B are diagrams showing examples of detecting a lost item in the search application output to the input/output unit 44 of the user terminal 40 according to the present embodiment. As shown in FIG. 7C, when the user inputs the lost item information from the user terminal 40 and registers the lost item, as shown in FIG. 8A, the lost item management unit 21 of the lost item management server 20 searches the lost item information database 22c. The lost item management unit 21 searches for lost item information that matches the input lost item information with a predetermined probability or more and transmits the lost item information to the user terminal 40. The control unit 41 displays a match screen 43d showing a list of the lost item information searched for by the input/output unit 44. In the example shown in FIG. 8A, the control unit 41 displays, in the input/output unit 44, a list of lost item candidates specified from the lost item information registered by the user and the matching rate with the lost item information.

Subsequently, as shown in FIG. 8B, in response to the selection by the user of the lost item owned by the user from the lost item candidates listed on the match screen 43d, the control unit 41 displays details of the lost item on the input/output unit 44 as a detail screen 43e. Then, for example, in response to tapping by the user on the detail screen 43e, the control unit 41 of the user terminal 40A designates the lost item candidate displayed on the detail screen 43e as the lost item of the user of the user terminal 40A. The control unit 41 associates the user identification information of the user terminal 40A with the lost item information of the designated lost item and transmits the information to the lost item management server 20. As a result, the lost item information of the lost item that has been selected and designated is associated with the user identification information of the user terminal 40A and stored in the lost item information database 22c in the lost item management server 20.

Returning to FIG. 6, in step ST8, the lost item management unit 21 of the lost item management server 20 determines whether the user identification information associated with the lost item information exists. That is, the lost item management unit 21 searches the lost item information database 22c to determine whether the user identification information exists in any of the user terminals 40 with respect to the lost item that substantially matches the lost item information generated by the feature extraction unit 214.

When the lost item management unit 21 determines in step ST8 that the user identification information associated with the lost item information exists (step ST8: Yes), the process proceeds to step ST9. In step ST9, the lost item management unit 21 transmits the lost item information and the user information including the user identification information associated with the lost item information to the work vehicle 30 that keeps the lost item based on the lost item information. Based on the acquired user information, the work vehicle 30 moves to a designated place such as the address, whereabouts, or current location of the owner of the lost item by a navigation system including the positioning unit 36 to deliver the lost item. The work vehicle 30 that has moved to the address, whereabouts, or current location of the owner carries out, by the work unit 38, the lost item kept in the keeping unit 39 and returns the lost item to the owner. This completes the management processing of the found item according to the present embodiment.

Further, when the determination unit 212 determines in step ST4 that the found item is waste (step ST4: Yes), the lost item management unit 21 of the lost item management server 20 transmits information on the determination result (determination information) indicating that the found item is waste to the work vehicle 30, and the process proceeds to step ST11. In step ST11, the control unit 31 of the work vehicle 30 outputs a control signal to the work unit 38 based on the acquired determination information, and stores the found item in the waste area of the keeping unit 39. The found items stored in the waste area are discarded after the work vehicle 30 moves to a predetermined waste treatment plant. This completes the management processing of the found item according to the present embodiment.

When the lost item management unit 21 determines in step ST8 that the user identification information associated with the lost item information does not exist (step ST8: No), the process proceeds to step ST10. In step ST10, the lost item management unit 21 determines whether a predetermined time has elapsed since the lost item was found.

When the lost item management unit 21 determines in step ST10 that the predetermined time has not elapsed since the lost item was found, the process returns to step ST8 and determines whether the user identification information associated with the lost item information exists. That is, steps ST8 and ST10 are repeatedly executed until the predetermined time elapses or until the user identification information associated with the lost item information is registered in the lost item management server 20. Note that the control unit 31 of the work vehicle 30 may determine whether the predetermined time has elapsed.

When the lost item management unit 21 determines in step ST10 that the predetermined time has elapsed, the information indicating that the predetermined time has elapsed is transmitted to the work vehicle 30. When the control unit 31 of the work vehicle 30 executes time measurement, the lost item management unit 21 does not have to transmit the information indicating that the predetermined time has elapsed to the work vehicle 30. When the work vehicle 30 acquires the information indicating that the predetermined time has elapsed, or the control unit 31 determines that the predetermined time has elapsed, the process proceeds to step ST11.

In step ST11, based on the control signal from the control unit 31 of the work vehicle 30, the work unit 38 stores the lost item in the waste area of the keeping unit 39, and then the work vehicle 30 moves to a predetermined waste treatment plant and discards the lost item. This completes the management processing of the found item according to the present embodiment.

There may be cases where the user of the user terminal 40B discovers the lost item that has been left behind by the user of the user terminal 40A. In this case, the user of the user terminal 40B can register the lost item using, for example, the search application (see FIG. 7A). Specifically, for example, the user of the user terminal 40B uses the imaging unit 45 to capture an image of the discovered lost item. The image information acquired by capturing the image is stored in the storage unit 42 of the user terminal 40B. The user reads the image information of the lost item from the storage unit 42 of the user terminal 40B and transmits the image information to the lost item management server 20. At this time, the image information of the lost item is associated with the user identification information and the location information of the user terminal 40B and transmitted to the lost item management server 20.

The lost item management unit 21 of the lost item management server 20 that has received the image information, the user identification information, and the location information stores the received information in the storage unit 22. The lost item management unit 21 transmits the location information received from the user terminal 40B to the work vehicle 30. The work vehicle 30 moves to the location of the received location information or the location designated by the user terminal 40B, and collects the lost item. After that, steps ST1 to ST11 shown in FIG. 6 are executed. The reward processing unit 213 of the lost item management unit 21 calculates the reward for the user of the user terminal 40B based on the image information transmitted from the user terminal 40B or the image information of the found item that is the lost item, the image of which was captured by the work vehicle 30. The lost item management unit 21 transmits the information of the reward calculated by the reward processing unit 213 to the user terminal 40B. This completes the management processing of the found item according to the present embodiment.

According to the embodiment of the present disclosure described above, it is determined whether a found item collected by a work vehicle 30 such as an automatic cleaning robot operating in a predetermined area such as a smart city is a lost item based on image information or video information acquired by capturing an image by the imaging unit 35a, the found item is kept, and when the found item is determined to be a lost item, the found item is posted on a website such as a bulletin board of the community. When the owner of the lost item is identified, the lost item is delivered to the owner. As a result, a moving body that performs automatic cleaning can realize functions of determining whether the found item is a lost item, collecting, keeping, and delivering the lost item.

Further, the lost item is not limited to the found item collected by the work vehicle 30. When a user who finds the lost item, for example, the user of the user terminal 40B, transmits the image information and the location information to the lost item management server 20, the lost item management server 20 can acquire the location where the lost item exists and the work vehicle 30 can collect the lost item, so that one moving body that performs automatic cleaning can realize functions of determining whether the found item is a lost item, collecting, keeping, and delivering the lost item.

Although the embodiment of the present disclosure has been specifically described above, the present disclosure is not limited to the above-described embodiment, and various modifications based on the technical idea of the present disclosure and embodiments combined with each other can be adopted. For example, the device configurations, display screens, and names given in the above-described embodiment are merely examples, and different device configurations, display screens, and names may be used as necessary.

For example, in the embodiment, deep learning using a neural network is mentioned as an example of machine learning, but machine learning based on other methods may be performed. Other supervised learning, such as support vector machines, decision trees, Naive Bayes, and k-nearest neighbors, may be used. Further, semi-supervised learning may be used instead of supervised learning. Furthermore, reinforcement learning or deep reinforcement learning may be used as machine learning.

Recording Medium

In the embodiment of the present disclosure, a program capable of executing a processing method by the operation management server 10 and the lost item management server 20 can be recorded in a recording medium that is readable by a computer and other machines or devices (hereinafter referred to as “computer or the like”). The computer or the like functions as the control units of the operation management server 10, the lost item management server 20, and the work vehicle 30 when the computer or the like is caused to read the program stored in the recording medium and execute the program. Here, the recording medium that is readable by the computer or the like means a non-transitory storage medium that accumulates information such as data and programs through an electrical, magnetic, optical, mechanical, or chemical action and from which the computer or the like can read the information. Examples of the recording medium removable from the computer or the like among the recording media above include, for example, a flexible disk, a magneto-optical disk, a compact disc read-only memory (CD-ROM), a compact disc rewritable (CD-R/W), a digital versatile disc (DVD), a Blu-ray disc (BD), a digital audio tape (DAT), a magnetic tape, and a memory card such as a flash memory. In addition, examples of the recording medium fixed to the computer or the like include a hard disk and a ROM. Further, a solid state drive (SSD) can be used as the recording medium removable from the computer or the like or as the recording medium fixed to the computer or the like.

### OTHER EMBODIMENTS

In the operation management server 10, the lost item management server 20, the work vehicle 30, and the user terminal 40 according to the embodiment, the “unit” can be read as a “circuit” or the like. For example, the communication unit can be read as a communication circuit.

The program to be executed by the operation management server 10 or the lost item management server 20 according to the embodiment may be configured to be stored in a computer connected to a network such as the Internet and provided through downloading via the network.

In the description of the flowchart in the present specification, the order of the processing between steps is clarified using expressions such as “first”, “after”, and “subsequently”. However, the order of processing required for realizing the embodiment is not always uniquely defined by those expressions. That is, the order of processing in the flowchart described in the present specification can be changed within a consistent range.

In addition, instead of a system equipped with one server, terminals capable of executing a part of the processing of the server may be distributed and arranged in a place physically close to the information processing device to apply edge computing technology that can efficiently communicate a large amount of data and shorten the arithmetic processing time.

Further effects and modifications can be easily derived by those skilled in the art. The broader aspects of the present disclosure are not limited to the particular details and representative embodiments shown and described above. Accordingly, various modifications may be made without departing from the spirit or scope of the general inventive concept as defined by the appended claims and their equivalents.

What is claimed is:

1. An information processing device comprising a processor including hardware, wherein the processor is configured to:
acquire image information acquired by capturing an image of an item collected by a moving body and store the image information in a storage unit;
determine whether the item in the image information read from the storage unit is waste;
when the processor determines that the item is not waste, output an instruction signal for keeping the item in the moving body and output information related to the item based on the image information; and
when user identification information associated with the information related to the item exists in the storage unit, output an instruction signal for moving to a predetermined location.

2. The information processing device according to claim 1, wherein:
the processor is configured to:
acquire the image information from the storage unit as an input parameter and input the input parameter to a determination learning model; and
output whether the item in the image information is waste as an output parameter; and
the determination learning model is a learning model generated by machine learning using an input and output data set that uses a plurality of pieces of image information acquired by capturing images of an item as a learning input parameter and a determination result of whether the item is waste as a learning output parameter.

3. The information processing device according to claim 1, wherein the processor is configured to, when the user identification information associated with the information related to the item does not exist for a predetermined time, determine that the item is waste and output a determination result.

4. The information processing device according to claim 1, wherein the processor is configured to, when the image information acquired by capturing the image of the item is acquired by a user terminal possessed by a user, output to the moving body an instruction signal for moving to a location where the user terminal that has captured the image of the item exists.

5. The information processing device according to claim 4, wherein the processor is configured to, when the image information acquired by capturing the image by the user terminal is acquired, calculate and output a reward for the user.

6. The information processing device according to claim 1, wherein the predetermined location is a location determined based on location information associated with the user identification information.

7. The information processing device according to claim 1, wherein the moving body is a work vehicle that is able to autonomously travel and clean a predetermined area.

8. An information processing system, comprising:
a first device including a work unit that collects an item, an imaging unit that captures an image of the item, and a first processor that includes hardware, that acquires operation information related to operation, and that outputs an instruction signal for moving based on the operation information; and
a second device including a second processor that includes hardware, that acquires image information acquired by capturing the image of the item collected by the first device and stores the image information in a storage unit, that determines whether the item in the image information read from the storage unit is waste, that, when the second processor determines that the item is not waste, outputs an instruction signal for keeping the item in the first device and outputs information related to the item based on the image information, and that, when user identification information associated with the information related to the item exists in the storage unit, outputs an instruction signal for moving to a predetermined location to the first device.

9. The information processing system according to claim 8, comprising a third device including a third processor that includes hardware, and that generates the operation information and outputs the operation information to the second device.

10. The information processing system according to claim 8, wherein the first device is provided on a moving body configured to be movable in a predetermined area.

11. The information processing system according to claim 10, wherein the moving body is a work vehicle that is able to autonomously travel and clean the predetermined area.

12. The information processing system according to claim 8, wherein:
the second processor is configured to:
acquire the image information from the storage unit as an input parameter and input the input parameter to a determination learning model; and
output whether the item in the image information is waste as an output parameter; and
the determination learning model is a learning model generated by machine learning using an input and output data set that uses a plurality of pieces of image information acquired by capturing images of a plurality of items as a learning input parameter and a determination result of whether each of the items is waste as a learning output parameter.

13. The information processing system according to claim 8, wherein the second processor is configured to, when the user identification information associated with the information related to the item does not exist for a predetermined time, determine that the item is waste and output a determination result.

14. The information processing system according to claim 8, wherein the second processor is configured to, when the image information acquired by capturing the image of the item is acquired by a user terminal possessed by a user, output to the first device an instruction signal for moving to a location where the user terminal that has captured the image of the item exists.

15. The information processing system according to claim 14, wherein the second processor is configured to, when the image information acquired by capturing the image by the user terminal is acquired, calculate and output a reward for the user.

16. The information processing system according to claim 8, wherein the predetermined location is a location determined based on location information associated with the user identification information.

17. A program that causes a processor including hardware to:
acquire image information acquired by capturing an image of an item collected by a moving body and store the image information in a storage unit;
determine whether the item in the image information read from the storage unit is waste;
when the processor determines that the item is not waste, output an instruction signal for keeping the item in the moving body and output information related to the item based on the image information; and
when user identification information associated with the information related to the item exists in the storage unit, output an instruction signal for moving to a predetermined location.

18. The program according to claim 17, causing the processor to:
acquire the image information from the storage unit as an input parameter and input the input parameter to a determination learning model; and
output whether the item in the image information is waste as an output parameter, wherein
the determination learning model is a learning model generated by machine learning using an input and output data set that uses a plurality of pieces of image information acquired by capturing images of an item as a learning input parameter and a determination result of whether the item is waste as a learning output parameter.

19. The program according to claim 17, causing the processor to, when the user identification information associated with the information related to the item does not exist for a predetermined time, determine that the item is waste and output a determination result.

20. The program according to claim 17, causing the processor to, when the image information acquired by capturing the image of the item is acquired by a user terminal possessed by a user, output to the moving body an instruction signal for moving to a location where the user terminal that has captured the image of the item exists.
